(19) United States
(12) Patent Application Publication
(10) Pub. No.: US 2024/0297364 A1
(43) Pub. Date: Sep. 5, 2024

(54) ACCUMULATOR BATTERY WITH ACTIVE THERMAL MANAGEMENT

(71) Applicant: Safran Electrical & Power, Blagnac Cedex (FR)

(72) Inventors: Kevin Kappler, Moissy-Cramayel (FR); Sébastien Thomassier, Moissy-Cramayel (FR)

(21) Appl. No.: 18/574,703

(22) PCT Filed: Jul. 1, 2022
(86) PCT No.: PCT/FR2022/051317

§ 371 Date: Dec. 27, 2023

(30) Foreign Application Priority Data
Jul. 6, 2021 (FR) FR2107307

(51) Int. Cl. H01M 10/6556; H01M 10/625; H01M 10/6554

(52) U.S. Cl. CPC H01M 10/6556; H01M 10/6554; H01M 10/625

(57) ABSTRACT

Battery comprising an accumulator in contact via one of its ends with a heat pipe via the stack of a strip, of a thermal pad and of a thermal-interface plate, the strip allowing electrical connection of the accumulator, the thermal pad being positioned between the strip and the thermal-interface plate so as to improve the area of contact and thermal conduction, the thermal-interface plate being thermally connected to the heat pipe, the heat pipe comprising a heat-transport fluid which transports heat energy and being connected to a heat exchanger allowing the heat-transport fluid to be heated or cooled.

### TECHNICAL FIELD

The invention relates to batteries, and more precisely, the cooling of such batteries.

### PRIOR ART

It is known that the performance of the accumulators of a battery degrades during operation because of their heating. It is therefore important to maintain the accumulators in a predetermined temperature range.

The operating temperature also has an impact on the service life of the accumulator and its ageing. The ageing also has an impact on the performance.

The 28V batteries currently used in the aeronautical field do not integrate an active cooling system. Only passive cooling by thermal conduction is used for the cooling of the batteries. Moreover, an assembly of the mechanical parts is used but only for maintaining the accumulators in the battery. They do not participate in the active cooling of the accumulators.

Today, the automobile field uses active cooling systems allowing to cool the batteries. A solution used is a floor in which a heat transfer fluid circulates. This floor being in contact with the accumulators, it allows to cool them by heat exchange.

Moreover, the failure of an accumulator causes a rapid increase in the surrounding temperature that can damage the other accumulators. The cooling of the battery allows to minimise or slow down this phenomenon.

It should be noted that the predetermined temperature range means that a heating of the battery can be necessary when the temperature is particularly low.

The current heating systems (i.e. heater) carry out only this function in a battery.

Moreover, still in the automobile field, the functions of active cooling and mechanical maintaining of the accumulators are dissociated and each function uses elements specific either to the active cooling, or to the mechanical maintaining. In other words, the cooling floor is only used to cool the accumulators while the other elements are only used to maintain the accumulators of the battery in position.

The cooling or the heating of the accumulators also means a slight waiting time before their availability.

There is a need to minimise the number of elements in a battery while maintaining and maximising the functions carried out by these elements.

### DISCLOSURE OF THE INVENTION

The object of the invention is a battery comprising an accumulator in contact by one of its ends with a heat pipe via the stack of a strip, a thermal pad and a thermal interface plate, the strip allowing to electrically connect the accumulator, the thermal pad being positioned between the strip and the thermal interface plate in order to improve the contact surface and the thermal conduction, the thermal interface plate being thermally connected to the heat pipe, the heat pipe comprising a heat transfer fluid ensuring the transport of thermal energy and connected to a heat exchanger allowing to heat or to cool the heat transfer fluid, one end of the accumulator being maintained by a mechanical maintaining plate, so as to avoid a lateral sliding of an accumulator and the mechanical maintaining plate being electrically insulating.

A mechanical maintaining plate can be disposed at each end of an accumulator.

An assembly of a heat pipe, a strip, a thermal pad and a thermal interface plate can be disposed at each end of an accumulator.

The battery can comprise a maintaining rod, means for maintaining under tension and two stacks of a strip, a thermal pad and a thermal interface plate, the first stack being in contact with one end of the accumulator and the second stack being in contact with the other end of the accumulator, the maintaining rod being disposed through the two stacks and being associated with the means for maintaining under tension allowing to maintain the accumulator under tension between the two stacks.

A heat pipe and a thermal interface plate can be comprised in the same plane.

A heat pipe can be disposed passing all the way through with respect to a thermal interface plate.

A thermal interface plate can be provided with a cooling channel in fluid contact with a heat pipe.

Another object of the invention is an aircraft provided with a battery as described above.

The battery according to the invention has the advantage of actively controlling the temperature of the accumulators while maintaining them in position.

The disadvantages of the prior art are thus avoided while reducing the number of necessary parts via a sharing of the functions of cooling and of mechanical maintaining. The mass and the bulk of the battery are thus reduced.

### BRIEF DESCRIPTION OF THE DRAWINGS

Other goals, features and advantages of the invention will appear upon reading the following description, given only as a non-limiting example and made in reference to the appended drawings in which:

FIG. 1 illustrates a view from above of a battery according to a first embodiment,

FIG. 2 illustrates a view from above of a battery according to a second embodiment,

FIG. 3 illustrates a cross-sectional view of a battery according to a third embodiment,

FIG. 4 illustrates a view from above of a battery according to a fourth embodiment.

### DETAILED DESCRIPTION

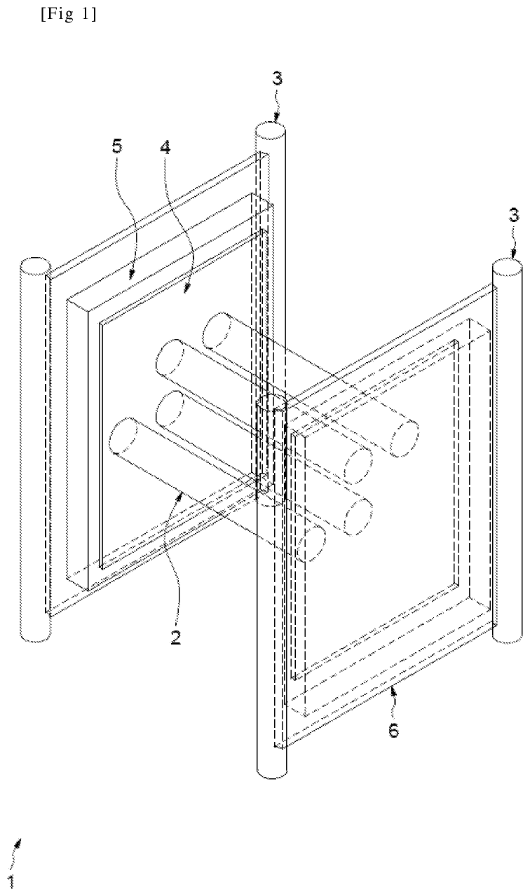

FIG. 1 illustrates a first embodiment of a battery 1, comprising an accumulator 2 in contact with a heat pipe 3 via the stack of a strip 4, a thermal pad 5 and a thermal interface plate 6. Advantageously, the battery 1 comprises several accumulators 2.

The strip 4 is disposed in contact with the accumulator 2, while the thermal interface plate 6 is in contact with a heat pipe 3. Advantageously, more than one heat pipe 3 can be provided.

A strip 4 is used to ensure the electric connection with the accumulator 2. It is directly positioned at one end (in other words, the pole) of an accumulator. A strip 4 is manufactured from a material that is simultaneously a very good electric and thermal conductor. When the battery 1 comprises several accumulators 2, they can be connected by the same end (electric pole) by a strip 4.

A thermal pad 5 is positioned between the strip 4 and the thermal interface plate 6 in order to ensure good thermal conduction by conforming to the various surface states of the strip 4 and of the thermal interface plate 6 and electric insulation.

Each thermal interface plate 6 is thermally connected to a heat pipe 3 in which a heat transfer fluid (liquid or gaseous) ensuring the transport of thermal energy circulates. The heat pipes 3 are connected to a heat exchanger allowing to heat or cool the heat transfer fluid. It is therefore possible to heat or to cool the accumulators. In a specific embodiment, the thermal interface plates 6 are provided with a cooling channel in fluid contact with a heat pipe 3. Several cooling channels can be provided. It is thus possible to bring the heat transfer fluid as close as possible to the accumulators 2 so as to improve the heat exchange by reducing the quantity of material participating in the heat exchange.

Via its structure, a thermal interface plate 6 also acts as protection against the propagation of a failure of one of the accumulators.

Preferably, a heat pipe 3, strip 4, thermal pad 5 and thermal interface plate 6 assembly is disposed at each end of an accumulator 2.

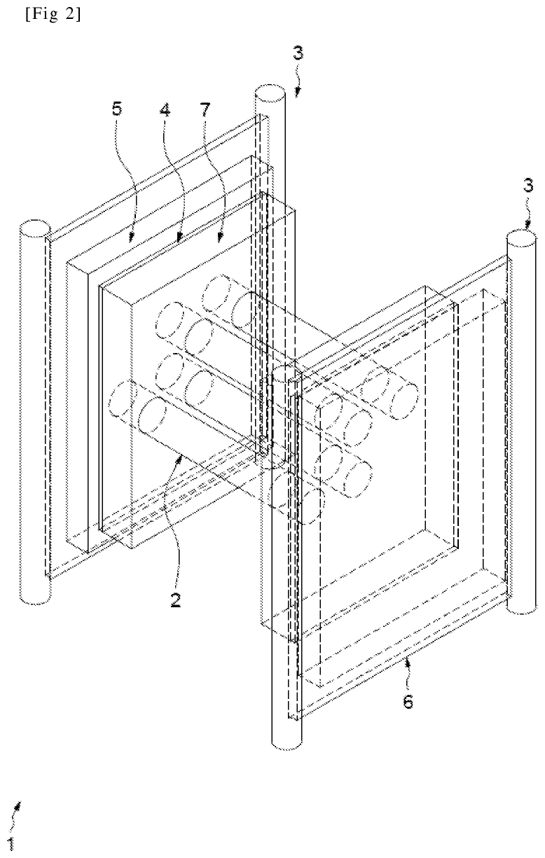

FIG. 2 illustrates a second embodiment, in which the end of the accumulator 2 is maintained by a mechanical maintaining plate 7. Advantageously, the end of several accumulators 2 can be maintained by the mechanical maintaining plate 7.

Such a mechanical maintaining plate 7 is provided with a hole for each accumulator end in contact with which it is disposed. Such maintaining allows to avoid the lateral sliding of an accumulator 2 that can lead to its ejection from the battery.

The end of an accumulator thus remains in direct contact with the stack of a strip 4, a thermal pad 5 and a thermal interface plate 6. The heat transfer is not modified. In a particular case, the mechanical maintaining plate 7 is electrically insulating.

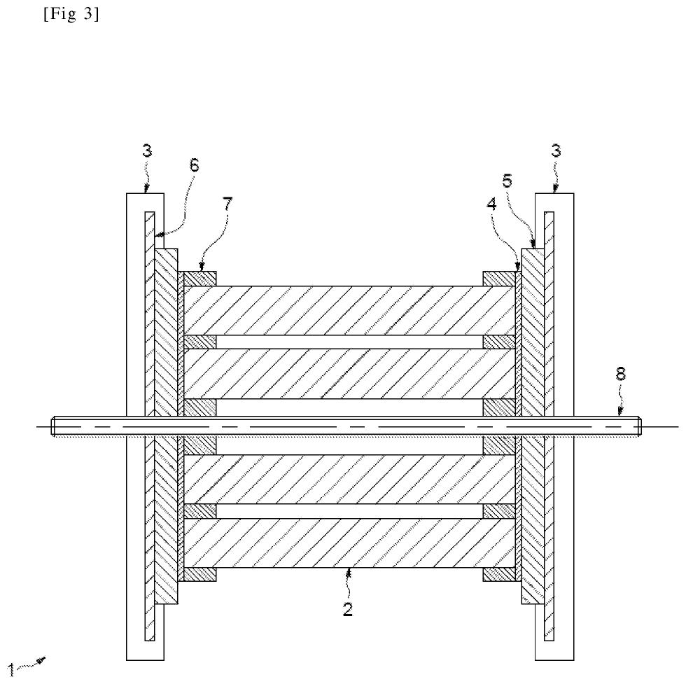

FIG. 3 illustrates a third embodiment of a battery, comprising a maintaining rod 8 in addition to the mechanical maintaining plates 7. The maintaining rod 8 is disposed through the stacks of a strip 4, a thermal pad 5 and a thermal interface plate 6 disposed at each end of an accumulator 2 and near the accumulator 2 so as to be maintained under pressure on the thermal interface plates 6. The maintaining under pressure is carried out for example by the association of bolts and of a thread at the rod end, or by any other means. The maintaining under pressure allows to ensure both the structural integrity of the battery and the contact between the accumulator 2 and the thermal interface plates 6 in order to favour the transfer of heat between the accumulator 2 and the heat pipe 3.

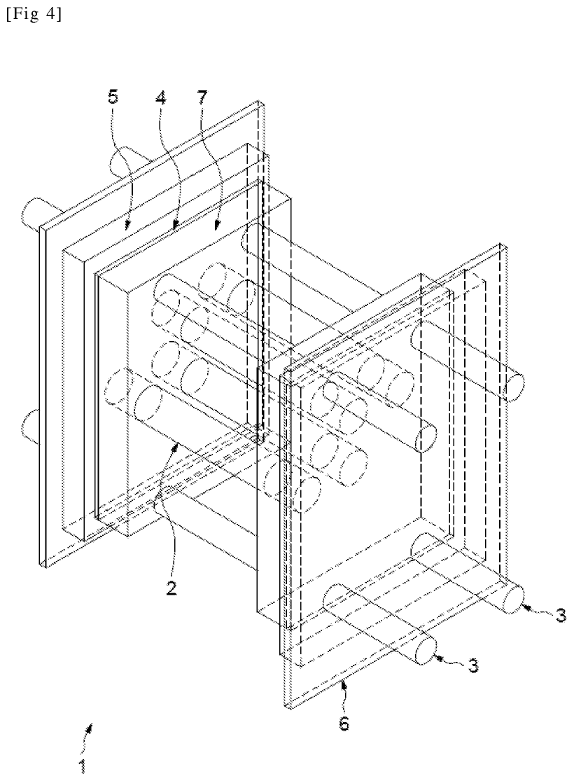

FIG. 4 illustrates a fourth embodiment, in which heat pipes 3 are disposed through the stacks of a strip 4, a thermal pad 5 and a thermal interface plate 6. Thus disposed, the heat pipes 3 contribute to the structural integrity of the battery while ensuring a heat exchange with the accumulators 2 through the stacks of a strip 4, a thermal pad 5 and a thermal interface plate 6. Alternatively, it is possible for a single heat pipe to pass through the stacks.

In the embodiments described above, reference is made to stacks of a strip 4, a thermal pad 5 and a thermal interface plate 6. A person skilled in the art will understand, however, upon reading this description that such stacks can comprise more than one strip 4, more than one thermal pad 5 and/or more than one thermal interface plate 6.

Various embodiments have also been described. A person skilled in the art will understand that these embodiments are not exclusive so that they can be combined with each other without going beyond the scope of the invention.

The battery allows to actively control the temperature of the accumulators so as to heat them or cool them to ensure the correct operation thereof and slow down the ageing thereof.

Via its structure, the battery also allows to ensure the maintaining in position of the accumulators, which is responsible for a gain in space and in mass.

1. Battery comprising an accumulator in contact by one of its ends with a heat pipe via the stack of a strip, a thermal pad and a thermal interface plate, the strip allowing to electrically connect the accumulator, the thermal pad being positioned between the strip and the thermal interface plate in order to improve the contact surface and the thermal conduction, the thermal interface plate being thermally connected to the heat pipe, the heat pipe comprising a heat transfer fluid ensuring the transport of thermal energy and connected to a heat exchanger allowing to heat or to cool the heat transfer fluid, one end of the accumulator being maintained by a mechanical maintaining plate, so as to avoid a lateral sliding of an accumulator, the mechanical maintaining plate being electrically insulating.

2. Battery according to claim 1, wherein a mechanical maintaining plate is disposed at each end of an accumulator.

3. Battery according to claim 1, wherein an assembly of a heat pipe, a strip, a thermal pad and a thermal interface plate is disposed at each end of an accumulator.

4. Battery according to claim 3, comprising a maintaining rod, means for maintaining under tension and two stacks of a strip, a thermal pad and a thermal interface plate, the first stack being in contact with one end of the accumulator and the second stack being in contact with the other end of the accumulator, the maintaining rod being disposed through the two stacks and being associated with the means for maintaining under tension allowing to maintain the accumulator under tension between the two stacks.

5. Battery according to claim 1, wherein a heat pipe and a thermal interface plate are comprised in the same plane.

6. Battery according to claim 1, wherein a heat pipe is disposed passing all the way through with respect to a thermal interface plate.

7. Battery according to claim 1, wherein a thermal interface plate is provided with a cooling channel in fluid contact with a heat pipe.

8. Aircraft provided with a battery according to claim 1.
